(19) United States
(12) Patent Application Publication
(10) Pub. No.: US 2023/0226807 A1
(43) Pub. Date: Jul. 20, 2023

(54) Polymer Composites and Methods of Making the Same

(71) Applicant: Temple University-Of The Commonwealth Systemof Higher Education, Philadelphia, PA (US)

(72) Inventors: Simona Percec, Philadelphia, PA (US); Jacob Celli, Drexei Hill (PA); Fei Ren, Philadelphia, PA (US)

(21) Appl. No.: 17/998,170

(22) PCT Filed: May 7, 2021
(86) PCT No.: PCT/US21/31235

§ 371 Date: Nov. 8, 2022

Related U.S. Application Data
(60) Provisional application No. 63/021,979, filed on May 8, 2020.

(51) Int. Cl. B32B 27/12; B32B 27/16; B32B 27/32; B32B 27/34; B32B 5/02; C08L 23/06; C08L 77/10; C08L 23/26

(52) U.S. Cl. CPC B32B 27/12; B32B 27/16; B32B 27/32; B32B 27/34; B32B 5/024; C08L 23/06; C08L 77/10; C08L 23/26; C08L 2207/062; C08L 2207/064; C08L 2207/068; C08L 2207/07; C08L 2203/12; B32B 2250/24; B32B 2262/0269; B32B 2323/043; B32B 2323/046; B32B 2323/10; B32B 2571/02

(57) ABSTRACT

Polymer composites may be made by providing a first polymer material; treating the first polymer material; providing a second polymer material; and pressing the first polymer material and the second polymer material. The polymer composites may be incorporated into ballistic resistant materials and soft armor articles.

### CROSS-REFERENCE TO RELATED APPLICATIONS

The present application claims priority to U.S. Provisional Application No. 63/021,979, filed May 8, 2020, which is incorporated by reference herein in its entirety

### STATEMENT REGARDING FEDERALLY SPONSORED RESEARCH OR DEVELOPMENT

This invention was made with government support under Grant No. W911NF-18-0269, awarded by the US Army Research Office. The Government has certain rights in the invention.

### BACKGROUND OF THE INVENTION

Poly-phenylene terephthalamide (PPTA) fabrics are used in a wide variety of industries and applications for impact resistance and shear resistance. These include body armors, cut-resistant wear and impact resistant helmets and padding. The fibers that make up the fabrics have outstanding mechanical properties such as, high tensile strength-to-weight ratio, energy absorption, and toughness. With these mechanical properties, there are still issues to be addressed. The fibers are highly anisotropic, and this can lead to issues in manufacturing and protecting. One way this is resolved is in the fabric form. The fabric allows for a better energy dispersion that can cause fiber failure. However, the fabrics are not perfect. PPTA fabrics for body armors are usually placed in layers. When intercepting a projectile, these layers will have a larger separation, in what is called blooming. This causes defects in the armor as some spots may have less protection. Another common issue in protective wear is that the projectile will shatter on impact and the PPTA fabrics are unable to capture this shrapnel. This will lead to pieces of the shrapnel impacting the wearer and cause harm.

There is need in the art for polymer composites with enhanced mechanical properties. The present invention satisfies this unmet need.

### SUMMARY OF THE INVENTION

In one aspect, the present invention relates to a method of fabricating a polymer composite, the method comprising the steps of: providing a first polymer material selected from the group consisting of high density polyethylene (HDPE), low density polyethylene (LDPE), extended chain polyolefin, high molecular weight polyethylene (HMWPE), ultra-high molecular weight polyethylene (UHMWPE), polypropylene, and ultra-high molecular weight polypropylene; treating the first polymer material; providing a second polymer material; and pressing the first polymer material and the second polymer material to form a polymer composite. In one embodiment, the first polymer material is ultra-high molecular weight polyethylene (UHMWPE). In one embodiment, the second polymer material comprises woven aramid. The present invention also relates to a polymer composite formed using this method.

In one embodiment, the first polymer material is treated with a flame, a supercritical fluid, an ion beam, an acid, a base, an ultraviolet source or a plasma. In one embodiment, the first polymer material is treated with a plasma selected from the group consisting of helium plasma, nitrogen plasma, argon plasma, oxygen plasma, water vapor plasma, ammonia plasma, halogen plasma, and air plasma. In one embodiment, the first polymer material is treated with an oxygen plasma.

In one embodiment, the method further comprises the step of layering the first polymer material and the second polymer material. In one embodiment, one or more layers of the first polymer material and one or more layers of the second polymer material are arranged in alternating layers. In one embodiment, the step of pressing the first polymer material and the second layering material further comprises the step of disposing an additive between the first polymer material and the second polymer material. In one embodiment, the additive is selected from the group consisting of a third polymer material, a buffering layer, an acrylate-based resin, and a ceramic material. In one embodiment, the first polymer material and the second polymer material are pressed using a hot press. In one embodiment, the first polymer material and the second polymer material are pressed at a temperature less than 200° C.

In another aspect, the present invention relates to a polymer composite, said composite comprising: a top layer of a first polymer material selected from the group consisting of high density polyethylene (HDPE), low density polyethylene (LDPE), extended chain polyolefin, high molecular weight polyethylene (HMWPE), ultra-high molecular weight polyethylene (UHMWPE), polypropylene, and ultra-high molecular weight polypropylene; a bottom layer of the first polymer material; and a second polymer material disposed between the top and bottom layers of the first polymer material. In one embodiment, the first polymer material is ultra-high molecular weight polyethylene (UHMWPE). In one embodiment, the second polymer material comprises a woven aramid fabric. In one embodiment, the weight ratio of the first polymer material to the second polymer material is between 2:1 and 1:2.

In another aspect, the present invention relates to a ballistic resistant material comprising the polymer composite, and to a soft armor article comprising the ballistic resistant material.

### BRIEF DESCRIPTION OF THE DRAWINGS

The following detailed description of various embodiments of the invention will be better understood when read in conjunction with the appended drawings. For the purpose of illustrating the invention, there are shown in the drawings illustrative embodiments. It should be understood, however, that the invention is not limited to the precise arrangements and instrumentalities of the embodiments shown in the drawings.

FIG. 1 is a flowchart of an exemplary method for the fabrication of a polymer composite material.

FIG. 2 is a schematic showing the fabrication process of the composite samples.

FIG. 3, comprising FIG. 3A and FIG. 3B, depicts the setup for the bullet testing procedure. FIG. 3A shows the testing stand without a sample. FIG. 3B shows the testing stand with a Kevlar® sample mounted.

FIG. 4, comprising FIG. 4A and FIG. 4B, depicts the results of the Kevlar® sample tests with .22LR ammunition. FIG. 4A is a photograph of the Kevlar® sample after the test. FIG. 4B is a photograph of the Kevlar® sample indents.

FIG. 5, comprising FIG. 5A and FIG. 5B, depicts the results of the untreated composite sample tests with .22LR ammunition. FIG. 5A is a photograph of the untreated sample after the test. FIG. 5B is a photograph of the untreated composite sample indents.

FIG. 6, comprising FIG. 6A and FIG. 6B, depicts the results of the treated sample tests with .22LR ammunition. FIG. 6A is a photograph of the treated sample after the test. FIG. 6B is a photograph of the treated composite sample indents.

### DETAILED DESCRIPTION

It is to be understood that the Figures and descriptions of the present invention have been simplified to illustrate elements that are relevant for a clear understanding of the present invention, while eliminating, for the purpose of clarity, many other elements found in composite materials and methods of making. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

As used herein, each of the following terms has the meaning associated with it in this section. Unless defined otherwise, all technical and scientific terms used herein generally have the same meaning as commonly understood by one of ordinary skill in the art to which this invention belongs.

The articles “a” and “an” are used herein to refer to one or to more than one (i.e. to at least one) of the grammatical object of the article. By way of example, “an element” means one element or more than one element.

For the purposes of the present invention, a “fiber” is an elongate body the length dimension of which is much greater than the transverse dimensions of width and thickness. The cross-sections of fibers for use in this invention may vary widely, and they may be circular, flat, or oblong in cross-section. Thus the term “fiber” includes filaments, ribbons, strips and the like having regular or irregular cross-section. A single fiber may be formed from just one filament or from multiple filaments.

A “fiber layer” as used herein may comprise a single-ply of unidirectionally oriented fibers, a plurality of non-consolidated plies of unidirectionally oriented fibers, a plurality of consolidated plies of unidirectionally oriented fibers, a woven fabric, a plurality of consolidated woven fabrics, or any other fabric structure that has been formed from a plurality of fibers, including felts, mats and other structures, such as those comprising randomly oriented fibers. A “layer” describes a generally planar arrangement. Each fiber layer will have both an outer top surface and an outer bottom surface. A “single-ply” of unidirectionally oriented fibers comprises an arrangement of non-overlapping fibers that are aligned in a unidirectional, substantially parallel array. This type of fiber arrangement is also known in the art as a “unitape”, “unidirectional tape”, “UD” or “UDT.” As used herein, an “array” describes an orderly arrangement of fibers or yarns, which is exclusive of woven fabrics, and a “parallel array” describes an orderly parallel arrangement of fibers or yarns. The term “oriented” as used in the context of “oriented fibers” refers to the alignment of the fibers as opposed to stretching of the fibers. The term “fabric” describes structures that may include one or more fiber plies, with or without molding or consolidation of the plies. For example, a woven fabric or felt may comprise a single fiber ply. A non-woven fabric formed from unidirectional fibers typically comprises a plurality of fiber plies stacked on each other and consolidated. When used herein, a “single-layer” structure refers to any monolithic fibrous structure composed of one or more individual plies or individual layers that have been merged, i.e. consolidated by low pressure lamination or by high pressure molding, into a single unitary structure together with a polymeric binder material. By “consolidating” it is meant that the polymeric binder material together with each fiber ply is combined into a single unitary layer. Consolidation can occur via drying, cooling, heating, pressure, or a combination thereof. Heat and/or pressure may not be necessary, as the fibers or fabric layers may just be glued together, as is the case in a wet lamination process. As described herein, “non-woven” fabrics include all fabric structures that are not formed by weaving. For example, non-woven fabrics may comprise a plurality of unitapes that are at least partially coated with a polymeric binder material, stacked/overlapped and consolidated into a single-layer, monolithic element, as well as a felt or mat comprising non-parallel, randomly oriented fibers that are preferably coated with a polymeric binder composition.

As used herein, the term “about” will be understood by persons of ordinary skill in the art and will vary to some extent depending on the context in which it is used. As used herein when referring to a measurable value such as an amount, a temporal duration, and the like, the term “about” is meant to encompass variations of ±20% or ±10%, more preferably ±5%, even more preferably ±1%, and still more preferably ±0.1% from the specified value, as such variations are appropriate to perform the disclosed methods.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

### DESCRIPTION

The present invention is based in part on the unexpected result that polymer composites of aramid and UHMWPE prevent mechanical failures that are observed in aramid fibers.

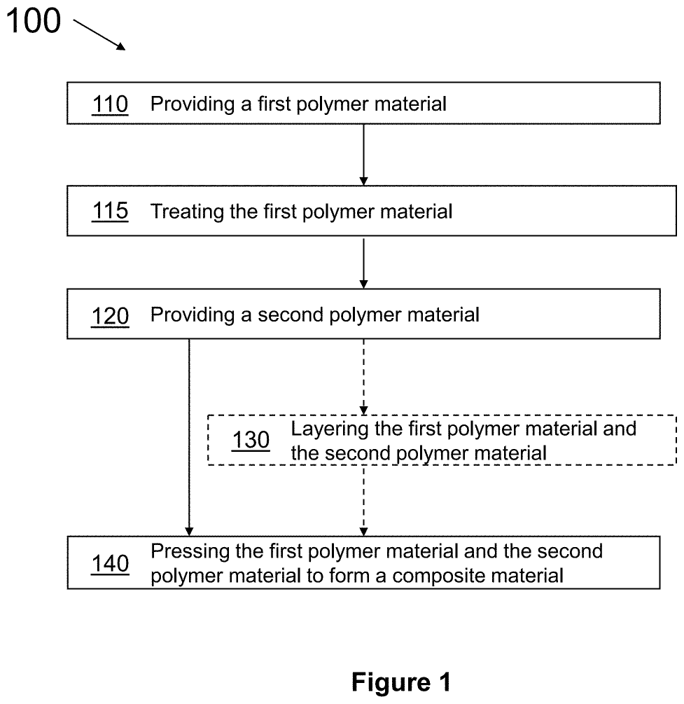

In one aspect, the invention relates to a method of producing a polymer composite material. Exemplary process 100 is shown in FIG. 1. In step 110, a first polymer material is provided. In step 115, the first polymer material is treated. In step 120, a second polymer material is provided. In step 130, the first polymer material and the second polymer material are pressed to create a composite material.

In steps 110 and 120, there is no limitation to the type of polymer material provided. In one embodiment, the polymer material comprises a single polymeric fiber. In one embodiment, the polymer material comprises a plurality of polymeric fibers. In one embodiment, the polymer material comprises a plurality of fibers in the form of a woven fabric or a non-woven fabric. In one embodiment, the polymer material comprises a sheet of the polymer.

The first polymer material and the second polymer material may independently comprise any polymer. Exemplary polymer materials include, but are not limited to, polyolefin fibers such as high density polyethylene (HDPE), low density polyethylene (LDPE), extended chain polyolefin fibers, high molecular weight polyethylene (HMWPE) fibers, ultra-high molecular weight polyethylene (UHMWPE) fibers, polypropylene fibers, ultra-high molecular weight polypropylene fibers; aramid fibers such as para-aramid fibers, polyamide fibers, polyimide fibers, and polyamide-imide fibers; polycarbonate polybutylene fibers; polystyrene fibers; polyester fibers such as polyethylene terephthalate fibers, polyethylene naphthalate fibers, and polycarbonate fibers; polyacrylate fibers; polybutadiene fibers; polyurethane fibers; extended chain polyvinyl alcohol fibers; fibers formed from fluoropolymers such as polytetrafluoroethylene (PTFE); epoxy fibers; phenolic resin polymeric fibers; polyvinyl chloride fibers; organosilicon polymeric fibers; extended chain polyacrylonitrile fibers; polybenzazole fibers such as polybenzoxazole (PBO) and polybenzothiazole (PBT) fibers; liquid crystal copolyester fibers; rigid rod fibers such as M5® fibers; and combinations thereof. In some embodiments of the invention, the polymer material comprises a copolymer or a block copolymer. In one embodiment, the polymer material is thermoplastic or thermosetting.

In one embodiment, the first polymer material and the second polymer material independently comprise a high-strength, high tensile modulus fiber such as may be used in the manufacture of ballistic resistant fabrics by one of skill in the art. Exemplary polymeric fibers useful for the formation of ballistic resistant fabrics include, but are not limited to, polyethylene, particularly extended chain polyethylene fibers, aramid fibers, polybenzazole fibers, liquid crystal copolyester fibers, polypropylene fibers, particularly highly oriented extended chain polypropylene fibers, polyvinyl alcohol fibers, polyacrylonitrile fibers and rigid rod fibers, particularly M5® fibers.

In one embodiment, the first polymer material and the second polymer material independently comprise extended chain polyethylenes having molecular weights of at least 500,000, at least one million or between two million and five million. Such extended chain polyethylene (ECPE) fibers may be grown in solution spinning processes such as described in U.S. Pat. No. 4,137,394 or 4,356,138, which are incorporated herein by reference, or may be spun from a solution to form a gel structure, such as described in U.S. Pat. Nos. 4,551,296 and 5,006,390, which are also incorporated herein by reference. In one embodiment, the polymer material comprises polyethylene fibers sold under the trademark SPECTRA® from Honeywell International Inc. SPECTRA® fibers are well known in the art and are described, for example, in U.S. Pat. Nos. 4,623,547 and 4,748,064.

In one embodiment, the first polymer material and the second polymer material independently comprise aramid (aromatic polyamide) or para-aramid fibers. In one embodiment, the aramid fibers are commercially available, such as those described in U.S. Pat. No. 3,671,542. In one embodiment, the polymer material comprises poly(p-phenylene terephthalamide) (PPTA) filaments produced commercially by DuPont Corporation under the trade name of KEVLAR®. In one embodiment, the polymer material comprises poly(m-phenylene isophthalamide) fibers produced commercially by DuPont under the trade name NOMEX® and or produced commercially by Teijin under the trade name TWARON®.

In one embodiment, the first polymer material and the second polymer material independently comprise polybenzazole fibers, for example those described in U.S. Pat. Nos. 5,286,833, 5,296,185, 5,356,584, 5,534,205 and 6,040,050, each of which is incorporated herein by reference. In one embodiment, the polybenzazole fibers are ZYLON® brand fibers from Toyobo Co. In one embodiment, the polymer material comprises liquid crystal copolyester fibers such as those described, for example, in U.S. Pat. Nos. 3,975,487; 4,118,372 and 4,161,470, each of which is incorporated herein by reference.

In one embodiment, the first polymer material and the second polymer material independently comprise polypropylene fibers. In one embodiment, the polymer material comprises highly oriented extended chain polypropylene (ECPP) fibers as described in U.S. Pat. No. 4,413,110, which is incorporated herein by reference. In one embodiment, the polymer material comprises polyvinyl alcohol (PV-OH) fibers such as those described, for example, in U.S. Pat. Nos. 4,440,711 and 4,599,267 which are incorporated herein by reference. In one embodiment, the polymer material comprises polyacrylonitrile (PAN) fibers such as those described, for example, in U.S. Pat. No. 4,535,027, which is incorporated herein by reference.

In one embodiment, the first polymer material and the second polymer material independently comprise rigid rod fibers. In one embodiment, the polymer material comprises M5® fibers. M5® fibers are manufactured by Magellan Systems International of Richmond, Va. and are described, for example, in U.S. Pat. Nos. 5,674,969, 5,939,553, 5,945,537, and 6,040,478, each of which is incorporated herein by reference.

In one embodiment, the first polymer material comprises a thin film. In one embodiment, the thickness of the thin film is between 0.05 and 0.1 mm. In one embodiment, the thickness of the thin film is about 0.075 mm.

In one embodiment, the first polymer material comprises a dopant to modulate the strength or other desired property of the material. Exemplary dopants include, but are not limited to, oxides such as Al₂O₃, SiO₂, Ta₂O₅, ZrO₂, HfO₂, ZnO, TiO₂, MgO, Cr₂O₃, Co₂O₃, NiO, FeO, Fe₂O₃, Ga₂O₃, GeO₂, V₂O₅, Y₂O₃, rare earth oxides, CaO, In₂O₃, SnO₂, PbO, PbO₂, MoO₃, and WO₃; nitrides such as TiN, TaN, Si₃N₄, AlN, Hf₃N₄, Zr₃N₄, WNx (wherein x=0.1-2.0), boron nitride (BN), carbon nitride, and alloys and nanolaminates thereof carbides such as SiC, TiC, boron carbide, WC, W₂C, Fe₃C, TaC, HfC, ZrC, MoC, and alloys and nanolaminates thereof; silicides such as NiSi, WSi₂, CoSi₂ and TiSi₂; borides such as TiB₂, WB and MgB₂; sulfides such as WS₂, MoS₂, copper sulfide, CaS₂, and La₂S₃; and ternary compounds such as TiCN, TiON, tungsten carbonitride, titanium aluminum nitride, SrTiO₃, La₂O₂S, LaAlO₃, and derivatives or combinations thereof.

In one embodiment, the first polymer material is subjected to one or more mechanical, chemical, thermal, chemomechanical, and/or chemothermal treatments. Among other things, these treatments can assist transmittance (imbibing) of molecules into the first polymer material, reduce the incidence and/or the severity of physical defects and chemical species, and/or selectively or non-selectively remove molecules from, or adding functional groups to, the first polymer material.

In one embodiment, treating the first polymer material comprises contacting the first polymer material with a corona, ozone, flame, ultraviolet radiation, or high vacuum. In one embodiment, treating the first polymer material comprises contacting the first polymer material with a super critical fluid. Exemplary super critical fluids include, but are not limited to, carbon dioxide, nitrous oxide, ethylene, propylene, propane, n-pentane, ethanol, ammonia, and water. In one embodiment, treating the first polymer material comprises contacting the first polymer material with ion beams, etching or implantation. Exemplary ion beams include, but are not limited to, argon, xenon, and nitrogen. In one embodiment, treating the first polymer material comprises contacting the first polymer material with a solution containing an acid, a base, or a chelating agent. Exemplary acids for use in the treatment solution include, but are not limited to, hydrochloric acid, acetic acid, and citric acid. Exemplary bases for use in the treatment solution include, but are not limited to, sodium hydroxide, potassium hydroxide, and the like. Exemplary chelating agents for use in the treatment solution include, but are not limited to, ethylenediamine tetra-acetic acid (EDTA), diethylenetriaminepentaacetic acid (DTPA), and nitrilotriacetic acid (NTA).

In one embodiment, treating the first polymer material comprises contacting the first polymer material with a plasma. Exemplary plasmas include, but are not limited to, helium plasma, nitrogen plasma, argon plasma, oxygen plasma, water vapor plasma, ammonia plasma, halogen plasmas, and air plasma. In one embodiment, a combination of plasmas is used. In one embodiment, plasma treatment of the first polymer increases adhesion between the first polymer material and the second polymer material.

In one embodiment, the plasma treating process is conducted at about atmospheric pressure, i.e. 1 atm (760 mm Hg (760 torr)), with a chamber temperature of about room temperature (70° F.-72° F.). In one embodiment, the temperature between the plasma electrodes and the first polymer material is about 100° C. In one embodiment, the plasma treating process is conducted under RF power at about 0.5 kW to about 3.5 kW. In one embodiment, the plasma treating process is conducted under RF power at about 1.0 kW to about 3.05 kW. In one embodiment, In one embodiment, the plasma treating process is conducted using an atmospheric plasma treater set at 2.0 kW. In one embodiment, this power is distributed over the width of the plasma treating zone (or the length of the electrodes) and this power is also distributed over the length of the substrate or fiber web at a rate that is inversely proportional to the line speed at which the fiber web passes through the reactive atmosphere of the plasma treater. This energy per unit area per unit time (watts per square foot per minute or W/ft²/min) or energy flux, is a useful way to compare treatment levels. In one embodiment, effective values for energy flux are from about 0.5 to about 200 W/ft²/min. In one embodiment, effective values for energy flux are from about 1 to about 100 W/ft²/min. In one embodiment, effective values for energy flux are from about 1 to about 80 W/ft²/min. In one embodiment, effective values for energy flux are from about 2 to about 40 W/ft²/min. In one embodiment, effective values for energy flux are from about 2 to about 20 W/ft²/min. In one embodiment, the total gas flow rate is approximately 16 liters/min, but this is not intended to be strictly limiting. In one embodiment, the plasma intensity is controlled by tuning the flow of the treatment gas.

In one embodiment, the plasma treating process is conducted for less than 10 minutes. In one embodiment, the plasma treating process is conducted for less than 9 minutes. In one embodiment, the plasma treating process is conducted for less than 8 minutes. In one embodiment, the plasma treating process is conducted for less than 7 minutes. In one embodiment, the plasma treating process is conducted for less than 6 minutes. In one embodiment, the plasma treating process is conducted for less than 5 minutes. In one embodiment, the plasma treating process is conducted for less than 4 minutes. In one embodiment, the plasma treating process is conducted for less than 3 minutes. In one embodiment, the plasma treating process is conducted for less than 2 minutes. In one embodiment, the plasma treating process is conducted for less than 90 seconds. In one embodiment, the plasma treating process is conducted for less than 75 seconds. In one embodiment, the plasma treating process is conducted for less than 60 seconds. In one embodiment, the plasma treating process is conducted for less than 45 seconds. In one embodiment, the plasma treating process is conducted for less than 30 seconds. In one embodiment, the plasma treating process is conducted more than 15 seconds.

In some embodiments, the method of the present invention further includes step 130, in which the first polymer material and the second polymer material are layered. In one embodiment, either or both of the first and the second polymer materials is provided as a sheet. In one embodiment, either or both of the first and the second polymer materials is provided as a woven fabric. In one embodiment, the first polymer material and the second polymer material are arranged in layers. In one embodiment, multiple layers of the first polymer material sandwich the second polymer material. In one embodiment, multiple layers of the second polymer material sandwich the first polymer material. In one embodiment, one or more layers of the first polymer material and one or more layers of the second polymer material are arranged in alternating layers.

In one embodiment, the step of pressing the first polymer material and the second layering material further comprises the step of disposing an additive between the first polymer material and the second polymer material. In one embodiment, the additive comprises a buffering layer.

In one embodiment, the additive comprises a third polymer material. In one embodiment, the third polymer material comprises any polymer described herein. In one embodiment, the third polymer material acts as a buffering layer. In one embodiment, the third polymer material may be of a type of material that is converted from a liquid curable composition into a cured polymeric material, in particular a resin, during the manufacturing of the polymer composite. The conversion of the liquid curable composition is not necessarily total, as minor amounts of its components may be lost (e.g. through evaporation) during the curing process or may remain as non-reacted components inside the cured polymer. For instance, the cure degree of an acrylate based resin is typically of at least 90%, preferably of at least 95%, said percentage indicating the amount of the unreacted acrylate unsaturations in the final cross-linked resin with respect to the initial composition.

In one embodiment, the additive comprises an acrylate-based resin. In one embodiment, the additive has flame retardant properties and/or a low coefficient of friction. In one embodiment, the additive comprises a polymer obtained by curing a liquid curable composition. Exemplary curable polymers include, but are not limited to, materials such as liquid curable silicones, Silicone Polymer Dimethyl Polysiloxane, and liquid plastisols such as vinyl plastisols.

In one embodiment, the additive comprises a self-assembling polymer. In one embodiment, the additive comprises a conjugated polymer. Exemplary conjugated polymers include, but are not limited to, poly-3,4-ethylene dioxythiophene (PEDOT), Polythiophene (PTh), polypyrrole (PPy), polyaniline (PANT), poly-phenylene vinylene (ppv) (PPV) and polydopamine (PDA), and the like.

In one embodiment, the additive comprises a ceramic material. Exemplary ceramics include, but are not limited to, oxides such as Al₂O₃, SiO₂, Ta₂O₅, ZrO₂, HfO₂, ZnO, TiO₂, MgO, Cr₂O₃, Co₂O₃, NiO, FeO, Fe₂O₃, Ga₂O₃, GeO₂, V₂O₅, Y₂O₃, rare earth oxides, CaO, In₂O₃, SnO₂, PbO, PbO₂, MoO₃, and WO₃; nitrides such as TiN, TaN, Si₃N₄, AlN, Hf₃N₄, Zr₃N₄, WNx (wherein x=0.1-2.0), boron nitride (BN), carbon nitride, and alloys and nanolaminates thereof; carbides such as SiC, TiC, boron carbide, WC, W₂C, Fe₃C, TaC, HfC, ZrC, MoC, and alloys and nanolaminates thereof; silicides such as NiSi, WSi₂, CoSi₂ and TiSi₂; borides such as TiB₂, WB and MgB₂; sulfides such as WS₂, MoS₂, copper sulfide, CaS₂, and La₂S₃; and ternary compounds such as TiCN, TiON, tungsten carbonitride, titanium aluminum nitride, SrTiO₃, La₂O₂S and LaAlO₃. Combinations of the above materials may be deposited as alloys or as nanolaminates, where a nanolaminate is a thin film composed of a series of alternating sub-layers with different compositions, such as Al₂O₃ and Ta₂O₅.

In one embodiment, the additive comprises a transition metal. Exemplary transition metals include, but are not limited to, titanium (Ti), vanadium (V), chromium (Cr), manganese (Mn), iron (Fe), cobalt (Co), nickel (Ni), copper (Cu), zinc (Zn), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), mercury (Hg), and bismuth (Bi).

In one embodiment, the additive comprises a metal oxide. In one embodiment, the metal oxide is a nanoparticle. Exemplary metal oxides include, but are not limited to, titanium dioxide (titanium(IV) oxide), TiO₂; titanium(II) oxide (titanium monoxide), TiO, a non-stoichiometric oxide; titanium(III) oxide (dititanium trioxide), Ti₂O₃; vanadium(II) oxide (vanadium monoxide), VO; vanadium(III) oxide (vanadium sesquioxide or trioxide), V₂O₃; vanadium(IV) oxide (vanadium dioxide), VO₂; vanadium(V) oxide (vanadium pentoxide), V₂O₅; chromium(II) oxide, CrO; chromium(III) oxide, Cr₂O₃; chromium dioxide (chromium(IV) oxide), CrO₂; chromium trioxide (chromium(VI) oxide), CrO₃; chromium(VI) oxide peroxide, CrO₅; manganese(II) oxide, MnO; manganese(II,III) oxide, Mn₃O₄; manganese(III) oxide, Mn₂O₃; manganese dioxide, (manganese(IV) oxide), MnO₂; manganese(VI) oxide, MnO₃; manganese(VII) oxide, Mn₂O₇; iron(II) oxide, FeO; iron(II) dioxide, FeO₂; iron(III) oxide, Fe₂O₃; cobalt(II) oxide, CoO; cobalt(III) oxide, Co₂O₃; nickel(II) oxide, NiO; nickel(III) oxide, Ni₂O₃; copper(I) oxide, Cu₂O; copper(II) oxide, CuO; copper peroxide, CuO₂; copper(III) oxide, Cu₂O₃; zinc oxide, ZnO; and mixed valence species or combinations thereof.

In one embodiment, the additive is a metal salt. In one embodiment, the metal salt is a salt of titanium, vanadium, chromium, manganese, iron, cobalt, nickel, copper, zinc, or any other metal, metalloid, or transition metal.

Exemplary titanium salts include titanium(IV) bromide, titanium carbonitride powder (T12CN), titanium(II) chloride, titanium(III) chloride, titanium(IV) chloride, titanium(III) chloride-aluminum chloride, titanium(III) fluoride, titanium(IV) fluoride, titanium(IV) iodide, and titanium(IV) oxysulfate. CuSO₄.5H₂O

Exemplary vanadium salts include vanadium (III) acetylacetonate, vanadium(II) chloride, vanadium(III) chloride, vanadium(IV) chloride, vanadium(III) chloride tetrahydrofuran complex, vanadium(V) oxychloride, and vanadium(V) oxyfluoride.

Exemplary chromium salts include chromium(II) chloride, chromium(III) bromide, chromium(III) chloride, chromium(III) chloride tetrahydrofuran complex, chromium(III) fluoride, chromium(III) nitrate, chromium(III) perchlorate, chromium(III) phosphate, chromium(III) sulfate, chromyl chloride, CrO, and potassium chromium(III) oxalate.

Exemplary manganese salts include manganese(II) bromide, manganese(II) carbonate, manganese(II) chloride, manganese(II) cyclohexanebutyrate, manganese(II) fluoride, manganese(III) fluoride, manganese(II) formate, manganese(II) iodide, manganese(II) molybdate, manganese(II) nitrate, manganese(II) perchlorate, and manganese(II) sulfate.

Exemplary iron salts include ammonium iron(II) sulfate, iron(II) bromide, iron(III) bromide, iron(II) chloride, iron(III) chloride, iron(III) citrate, iron(II) fluoride, iron(III) fluoride, iron(II) iodide, iron(II) molybdate, iron(III) nitrate, iron(II) oxalate, iron(III) oxalate, iron(II) perchlorate, iron(III) phosphate, iron(III) pyrophosphate, iron(II) sulfate, iron(III) sulfate, iron(II) tetrafluoroborate, and potassium hexacyanoferrate(II).

Exemplary cobalt salts include cobalt (II) naphthenate, ammonium cobalt(II) sulfate, cobalt(II) benzoylacetonate, cobalt(II) bromide, cobalt(II) carbonate, cobalt(II) chloride, cobalt(II) cyanide, cobalt(II) fluoride, cobalt(III) fluoride, cobalt(II) hydroxide, cobalt(II) iodide, cobalt(II) nitrate, cobalt(II) oxalate, cobalt(II) perchlorate, cobalt(II) phosphate, cobalt(II) sulfate, cobalt(II) tetrafluoroborate, cobalt(II) thiocyanate, cobalt(II) thiocyanate, trans-dichlorobis(ethylenediamine)cobalt(III) chloride, Hexaamminecobalt(III) chloride, pentaamminechlorocobalt(III) chloride.

Exemplary nickel salts include ammonium nickel(II) sulfate, bis(ethylenediamine)nickel(II) chloride, nickel(II) acetate, nickel(II) bromide, nickel(II) bromide ethylene glycol dimethyl ether complex, nickel(II) bromide 2-methoxyethyl ether complex, nickel carbonate, nickel(II) carbonate hydroxide, nickel (II) chloride, nickel(II)cyclohexanebutyrate, nickel (II) fluoride, nickel (II) hexafluorosilicate, nickel(II) hydroxide, nickel(II) iodide, nickel (II) nitrate, nickel(II) oxalate, nickel(II) perchlorate, nickel(II) sulfamate, nickel(II) sulfate, potassium nickel(IV) paraperiodate, and potassium tetracyanonickelate (II).

Exemplary copper salts include: copper acetate, copper hexanoate, copper-2-ethylhexanoate copper carbonate, copper (II) acetylacetonate, copper(1) bromide, copper(II) bromide, copper(1) bromide dimethyl sulfide complex, copper(1) chloride, copper(II) chloride, copper(1) cyanide, copper(II) cyclohexanebutyrate, copper(II) fluoride, copper(1I) formate, copper(II) D-gluconate, copper(II) hydroxide, copper(II) hydroxide phosphate, copper(1) iodide, copper(II) molybdate, copper(II) nitrate, copper(II) perchlorate, copper(II) pyrophosphate, copper(II) selenite, copper(II) sulfate, copper(II) tartrate, copper(II) tetrafluoroborate, copper(1) thiocyanate, and tetraamminecopper(II) sulfate.

Exemplary zinc salts include zinc bromide, zinc chloride, zinc citrate, zinc cyanide, zinc fluoride, zinc hydroxide, zinc hexafluorosilicate, zinc iodide, zinc methacrylate, zinc molybdate, zinc nitrate, zinc oxalate, zinc perchlorate, zinc phosphate, zinc selenite, zinc sulfate, zinc tetrafluoroborate, and zinc p-toluenesulfonate.

In one embodiment, the additive is a planar material. The planar material can be any planar material known to one of skill in the art. In one embodiment, the planar material is a substantially flat material of atomic-level or near-atomic-level thickness. In one embodiment, the planar material is substantially circular in shape. In one embodiment, the diameter of the planar material is between 100 nm and 300 nm. In one embodiment, the planar material has a continuous flat surface with a compact structure. In one embodiment, the surface of the planar material has no defects. Exemplary planar materials include, but are not limited to, graphene, graphene oxide, reduced graphene oxide, carbon nitride, graphyne, hexagonal boron nitride, silicene, germanene, black phosphorous (phosphorene), transition metal dichalcogenides, and combinations thereof. Exemplary transition metal dichalcogenides include MoS₂, TiS₂, WS₂, VS₂, TiSe₂, MoSe₂, WSe₂, TaSe₂, NbSe₂, NiTe₂, and Bi₂Te₃, and can be produced by any method known to those of skill in the art.

In step 140, the first polymer material and the second polymer material are be pressed using any method known to those of skill in the art. In one embodiment, the polymer materials are pressed using a hot press. In one embodiment, the polymer materials are pressed at a temperature greater than 100° C. In one embodiment, the polymer materials are pressed at a temperature greater than 110° C. In one embodiment, the polymer materials are pressed at a temperature greater than 120° C. In one embodiment, the polymer materials are pressed at a temperature greater than 130° C. In one embodiment, the polymer materials are pressed at a temperature greater than 140° C. In one embodiment, the polymer materials are pressed at a temperature greater than 150° C. In one embodiment, the polymer materials are pressed at a temperature greater than 160° C. In one embodiment, the polymer materials are pressed at a temperature greater than 170° C. In one embodiment, the polymer materials are pressed at a temperature greater than 180° C. In one embodiment, the polymer materials are pressed at a temperature of about 190° C. In one embodiment, the polymer materials are pressed at a temperature less than 200° C.

In one embodiment, the polymer materials are pressed for greater than 10 minutes. In one embodiment, the polymer materials are pressed for greater than 15 minutes. In one embodiment, the polymer materials are pressed for greater than 20 minutes. In one embodiment, the polymer materials are pressed for greater than 25 minutes. In one embodiment, the polymer materials are pressed for greater than 30 minutes. In one embodiment, the polymer materials are pressed for greater than 35 minutes. In one embodiment, the polymer materials are pressed for greater than 40 minutes. In one embodiment, the polymer materials are pressed for greater than 45 minutes. In one embodiment, the polymer materials are pressed for greater than 50 minutes. In one embodiment, the polymer materials are pressed for greater than 55 minutes. In one embodiment, the polymer materials are pressed for about 60 minutes. In one embodiment, the polymer materials are pressed for less than 120 minutes.

In one embodiment, the step of pressing the first polymer layer and the second polymer layer may further comprise the step of stretching the first polymer layer and the second polymer layer. The polymer layers may be stretched using any method known in the art, such as hot drawing, hot stretching, spin drawing, or roller drawing. In one embodiment, stretching at a specific temperature and speed causes the polymer chains to align in the direction of stretching. In one embodiment, the polymer layers are stretched until continuous application of force no longer changes the length of the film. In one embodiment, the polymer layers are stretched for at least 30 seconds. In one embodiment, the polymer layers are stretched for at least 60 seconds. In one embodiment, the polymer layers are stretched for at least 90 seconds. In one embodiment, the polymer layers are stretched for at least 120 seconds.

In one embodiment, stretching the polymer layers results in elongation of the polymer layers. In one embodiment, the polymer layers are stretched to at least 150% of their original length. In one embodiment, the polymer layers are stretched to at least 200% of their original length. In one embodiment, the polymer layers are stretched to at least 250% of their original length. In one embodiment, the polymer layers are stretched to at least 300% of their original length. In one embodiment, the polymer layers are stretched to at least 350% of their original length. In one embodiment, the polymer layers are stretched to at least 400% of their original length. In one embodiment, the polymer layers are stretched to at least 450% of their original length. In one embodiment, the polymer layers are stretched to at least 500% of their original length. In one embodiment, the polymer layers are stretched to at least 550% of their original length.

### Polymer Composites

The present invention relates in part to novel polymer composite materials formed using the methods described herein.

In one embodiment, the polymer composite comprises a top layer of a first polymer material, a bottom layer of a first polymer material, and a second polymer material disposed between the top and bottom layers of the first polymer material.

In one embodiment, the first polymer material comprises any polymer material described herein. In one embodiment, the first polymer material comprises ultra-high molecular weight polyethylene (UHMWPE). In one embodiment, the first polymer material comprises a dopant. Exemplary dopants include, but are not limited to, the additives described herein.

In one embodiment, the second polymer material comprises any polymer material described herein. In one embodiment, the second polymer material comprises aramid fibers. In one embodiment, the second polymer material comprises a woven aramid fabric.

In one embodiment, the polymer composite is a fiber. In one embodiment, the polymer composite is a sheet. In one embodiment, the polymer composite is a woven article.

In one embodiment, the top layer of the first polymer material and the bottom layer of the first polymer material each comprise an exposed surface. In one embodiment, the exposed surface is not in contact with the second polymer material. In one embodiment, the exposed surface is in contact with the air. In one embodiment, the exposed surface is open to the surrounding conditions.

In one embodiment, at least one of the top layer of the first polymer material and the bottom layer of the first polymer material comprises an interfacial surface which is in contact with the second polymer material. In one embodiment, the interfacial surface is not exposed to the surrounding conditions. In one embodiment, the interfacial surface is not in contact with the air. In one embodiment, 50% to 100% of the interfacial surface is in direct contact with the second polymer material. In one embodiment, some portion of the interfacial surface of the top layer of the first polymer material is in direct contact with the interfacial surface of the bottom layer of the first polymer material, such as between strands or the weave/weft of the second polymer material.

In one embodiment, the chemical make-up of the interfacial surface is different from that of the exposed surface. In one embodiment, the interfacial surface comprises a greater proportion of oxygen atoms relative to carbon atoms. In one embodiment, the interfacial surface comprises a higher degree of functionalization. In one embodiment, the interfacial surface comprises a greater proportion of free radicals. In one embodiment, the interfacial surface comprises a greater degree of oxygen-containing functional groups such as hydroxy groups, carbonyls, carboxylic acids, ethers, and esters. In one embodiment, the interfacial surface comprises a greater degree of unsaturation relative to the exposed surface. In one embodiment, the atoms of the interfacial surface have a greater oxidation state than the atoms of the exposed surface.

In one embodiment, the weight ratio of the first polymer material to the second polymer material in the polymer composite is between 1:10 and 10:1. In one embodiment, the weight ratio of the first polymer material to the second polymer material in the polymer composite is between 1:9 and 9:1. In one embodiment, the weight ratio of the first polymer material to the second polymer material in the polymer composite is between 1:8 and 8:1. In one embodiment, the weight ratio of the first polymer material to the second polymer material in the polymer composite is between 1:7 and 7:1. In one embodiment, the weight ratio of the first polymer material to the second polymer material in the polymer composite is between 1:6 and 6:1. In one embodiment, the weight ratio of the first polymer material to the second polymer material in the polymer composite is between 1:5 and 5:1. In one embodiment, the weight ratio of the first polymer material to the second polymer material in the polymer composite is between 1:4 and 4:1. In one embodiment, the weight ratio of the first polymer material to the second polymer material in the polymer composite is between 1:3 and 3:1. In one embodiment, the weight ratio of the first polymer material to the second polymer material in the polymer composite is between 1:2 and 2:1. In one embodiment, the weight ratio of the first polymer material to the second polymer material in the polymer composite is between 1:1 and 2:1.

### Ballistic Resistant Materials

In one aspect, the present invention relates in part to a ballistic resistant material comprising a polymer composite described herein. For example, the ballistic resistant material may comprise flexible, soft armor articles; rigid, hard armor articles; or fabrics comprising the polymer composite described herein.

Exemplary flexible, soft articles include, but are not limited to, garments such as vests, pants, hats, or other articles of clothing, or covers or blankets used by military personnel to defeat a number of ballistic threats, such as 9 mm full metal jacket (FMJ) bullets, and a variety of fragments generated due to explosion of hand-grenades, artillery shells, Improvised Explosive Devices (IED) and other such devises encountered in military and peace keeping missions. As used herein, “soft” or “flexible” armor is armor that does not retain its shape when subjected to a significant amount of stress and/or is incapable of being free-standing without collapsing. In one embodiment, garments comprising the polymer composite of the invention may be formed through methods conventionally known in the art. In one embodiment, the garment is formed by adjoining the ballistic resistant articles of the invention with an article of clothing. For example, a vest may comprise a generic fabric vest that is adjoined with the ballistic resistant structures of the invention, whereby the inventive articles are inserted into strategically placed pockets. As used herein, the terms “adjoining” or “adjoined” are intended to include attaching, such as by sewing or adhering and the like, as well as un-attached coupling or juxtaposition with another fabric, such that the ballistic resistant articles comprising the polymer composite of the invention may optionally be easily removable from the vest or other article of clothing.

Exemplary hard armor articles include, but are not limited to, helmets, panels for military vehicles, or protective shields, which have sufficient mechanical strength so that the hard armor article maintains structural rigidity when subjected to a significant amount of stress and is capable of being freestanding without collapsing. In one embodiment, the polymer composite can be cut into a plurality of discrete sheets and stacked for formation into an article or they can be formed into a precursor which is subsequently used to form an article. Such techniques are well known in the art.

### EXPERIMENTAL EXAMPLES

The invention is now described with reference to the following Examples. These Examples are provided for the purpose of illustration only, and the invention is not limited to these Examples, but rather encompasses all variations that are evident as a result of the teachings provided herein.

### Example 1: UHMWPE Reinforced Kevlar® Composite Panels

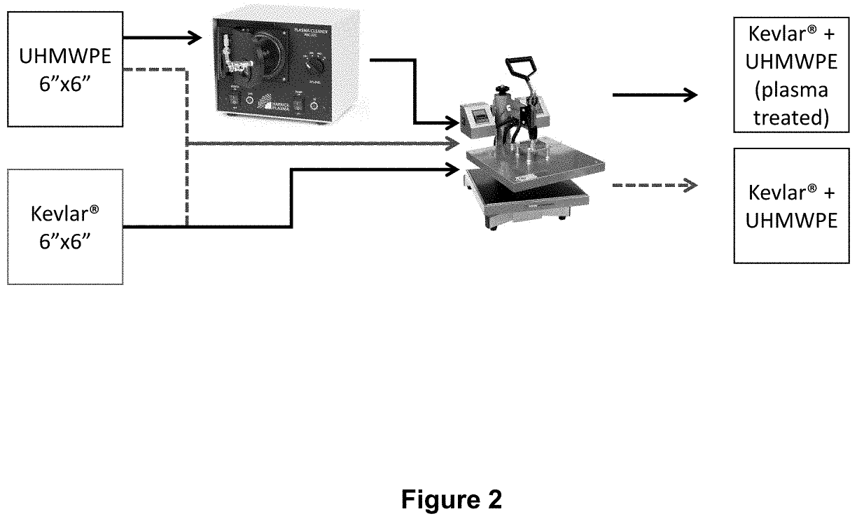

Three types of samples were fabricated: 1) Kevlar® fabrics, 2) Kevlar® fabrics reinforced with UHMWPE, and 3) Kevlar® fabrics reinforced with plasma-treated UHMWPE. For the Kevlar® fabric sample, 6″×6″ squares were cut from a roll of Kevlar® 29 and stitched together. For the composite panels, 6″×6″ Kevlar® fabrics and a selected number of UHMWPE thin films were layered and hot pressed at 190° C. for 1 hr. Plasma treatment was also performed on some UHMWPE thin films prior to the hot pressing process to promote binding between the Kevlar® and the UHMWPE layers. The fabrication process of the composite samples was illustrated in FIG. 2.

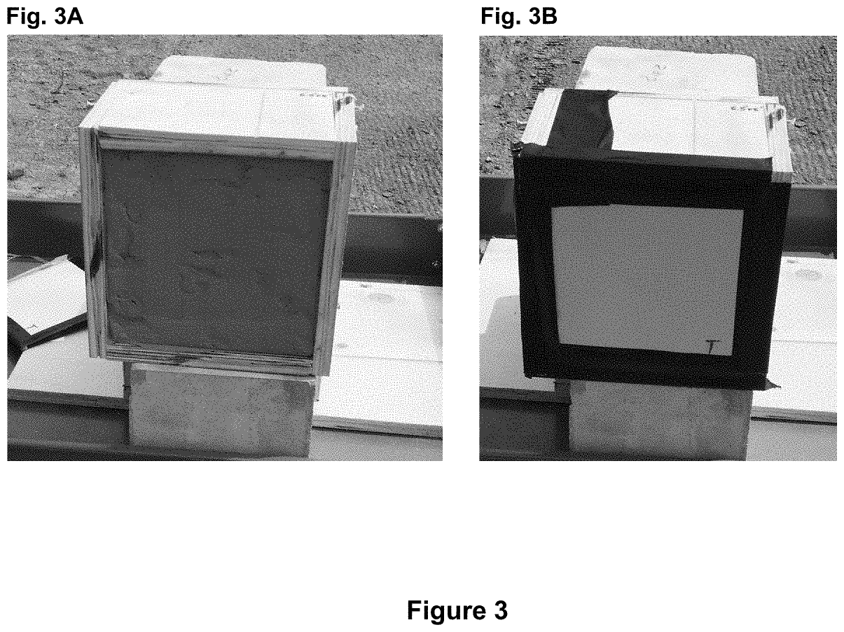

Bullet testing was conducted according to the NIJ Standard 0101.06 (NIJ Standard 0101.06, Ballistic Resistance of Body Armor, National Institute of Justice, U.S. Department of Justice, Washington, D.C., July 2008). Prior to each test, the prepared samples were fixed onto a wooden box (6″×6″×6″) filled with modeling clay (Roma Plastilina No 1) (FIG. 3). During the test, samples were tested from a distance of 15 feet using handguns with .22LR and 9 mm caliber ammunition. The .22LR ammunition (CCI) has a mass of 40 grain (2.59 grams) and an initial speed of 1070 ft/s (326.1 m/s). For each test, three shots were made. After each test, the damaged sample was examined and removed from the wooden box. Then, the diameter and depth of the penetration holes in the clay were measured. Finally, the holes were filled and the clay was leveled for next test. The data from the tests are presented in Table 1.

TABLE 1
Sample specifications and testing results

| | | | | | | Indentation | Indentation |
|---|---|---|---|---|---|---|---|
| Sample ID | Composition | Dimension | Weight | Ammunition | Penetration | Width | Depth |
| Kevlar ® #1 | Kevlar ® | 6 in × 6 in | 83.8 g | CCI .22lr | No | 29.7 +/− | 38.7 +/− |
| | | | | | | 0.5 mm | 8.2 mm |
| Kevlar ®- | 5:4 | 6 in × 6 in | 82.7 g | CCI .22lr | Yes | 23.7 +/− | 56 +/− |
| UHMWPE #1 | PE:Kevlar ® | | | | | 6.3 m | 13.4 mm |
| Kevlar ®- | 5:4 | 6 in × 6 in | 82.2 g | CCI .22lr | Yes | 32.3 +/− | 20.5 +/− |
| UHMWPE(plasma) #1 | PE:Kevlar ® | | | | | 5.4 mm | 5.8 mm |

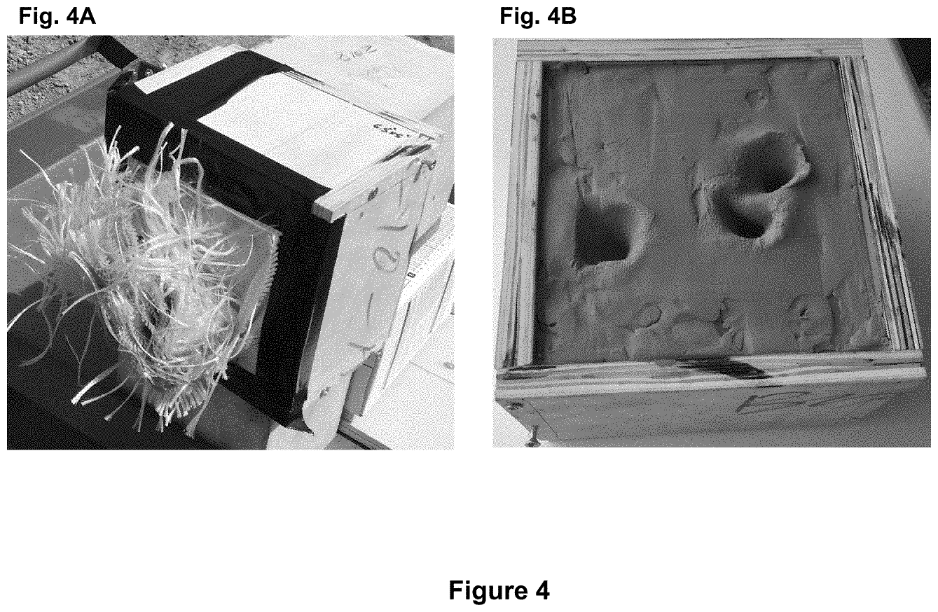

Testing with the .22LR Ammunition, the pure Kevlar® panel did not show full penetration of the 0.221r ammo, although the sample was completely destroyed (FIG. 4A). The projectiles were all captured inside of the fabric weave. However, large indentations were observed in the backing clay (FIG. 4B) with an average penetration depth of 38 mm and an average diameter of 30 mm (Table 1). This type of damage could result in severe or lethal trauma to the protected.

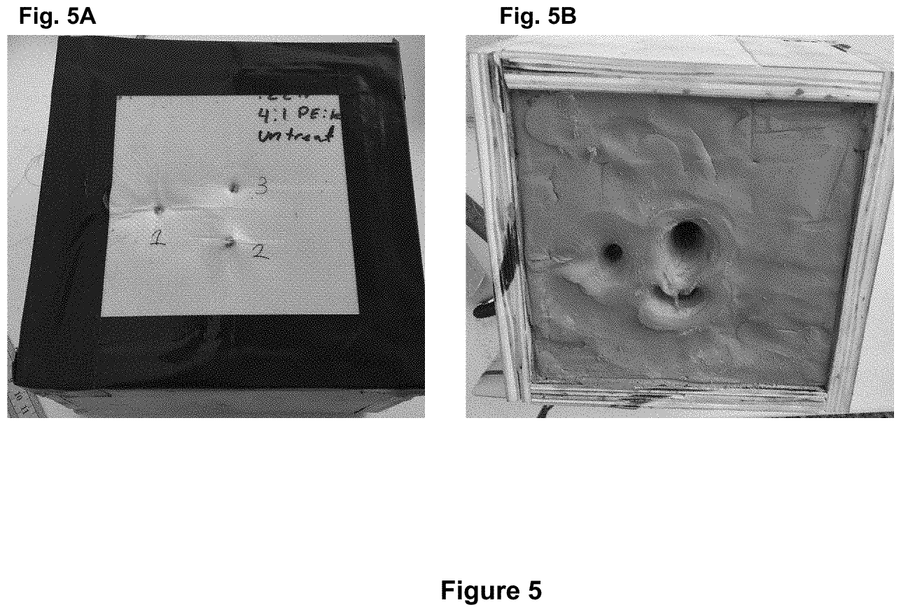

FIG. 5A shows the picture of the Kevlar®-UHMWPE composite panel after testing. It suffered two full projective penetrations, and third was trapped in the sample. The penetrated projectiles went ˜61 mm into the clay and the unpenetrated projectile indentation only went ˜47 mm (Table 1, FIG. 5B). The Kevlar®-UHMWPE sample didn't show improvement over the pure Kevlar® sample with respect to protection against .22LR ammunition.

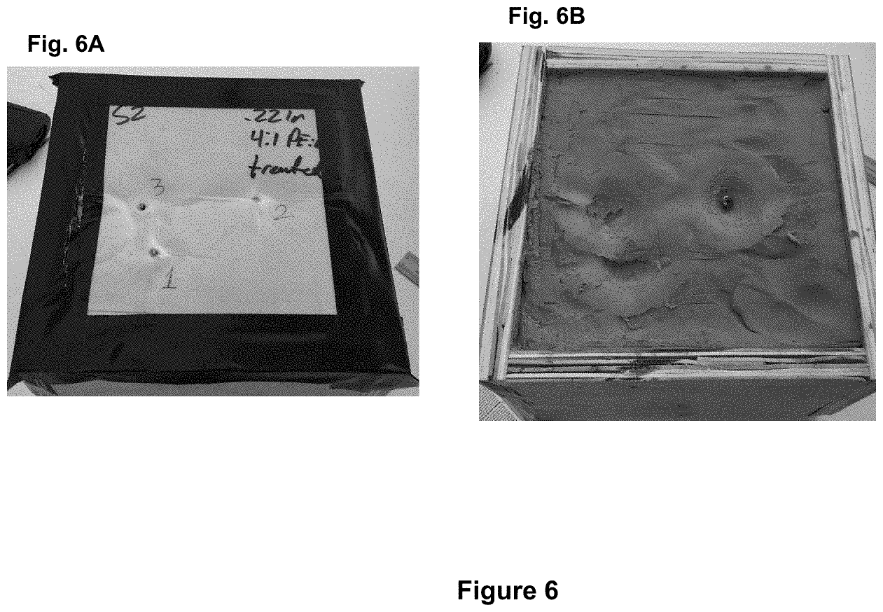

FIG. 6A shows the picture of the Kevlar®-plasma treated UHMWPE composite panel after testing. There was one fully penetrated projectile with a depth of 19.5 mm and width of 34 mm (Table 1, FIG. 6B). However, the indentations were very shallow, being only ˜21 mm deep. The indentation width was approximately 31 mm. In comparison to the pure Kevlar® sample, this composite panel showed better protection against projectile penetration.

These results on the protection against .22LR ammunition indicate the composite panel consisting of Kevlar® fabrics and plasma-treated UHMWPE had a better performance than the Kevlar® sample.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

1. A method of fabricating a polymer composite, the method comprising the steps of:
providing a first polymer material selected from the group consisting of high density polyethylene (HDPE), low density polyethylene (LDPE), extended chain polyolefin, high molecular weight polyethylene (HMWPE), ultra-high molecular weight polyethylene (UHMWPE), polypropylene, and ultra-high molecular weight polypropylene;
treating the first polymer material;
providing a second polymer material; and
pressing the first polymer material and the second polymer material to form a polymer composite.

2. The method of claim 1, wherein the first polymer material is ultra-high molecular weight polyethylene (UHMWPE).

3. The method of claim 1, wherein the second polymer material comprises woven aramid.

4. The method of claim 1, wherein the first polymer material is treated with a flame, a supercritical fluid, an ion beam, an acid, a base, an ultraviolet source, or a plasma.

5. The method of claim 1, wherein the first polymer material is treated with a plasma selected from the group consisting of helium plasma, nitrogen plasma, argon plasma, oxygen plasma, water vapor plasma, ammonia plasma, halogen plasma, and air plasma.

6. The method of claim 1, wherein the first polymer material is treated with an oxygen plasma.

7. The method of claim 1, further comprising the step of layering the first polymer material and the second polymer material.

8. The method of claim 1, wherein one or more layers of the first polymer material and one or more layers of the second polymer material are arranged in alternating layers.

9. The method of claim 1, wherein the step of pressing the first polymer material and the second layering material further comprises the step of disposing an additive between the first polymer material and the second polymer material.

10. The method of claim 9, wherein the additive is selected from the group consisting of a third polymer material, a buffering layer, an acrylate-based resin, and a ceramic material.

11. The method of claim 1, wherein the first polymer material and the second polymer material are pressed using a hot press.

12. The method of claim 1, wherein the first polymer material and the second polymer material are pressed at a temperature less than 200° C.

13. A polymer composite formed by the method of claim 1.

14. A ballistic resistant material comprising the polymer composite of claim 13.

15. A soft armor article comprising the ballistic resistant material of claim 14.

16. A polymer composite, comprising:
a top layer of a first polymer material selected from the group consisting of high density polyethylene (HDPE), low density polyethylene (LDPE), extended chain polyolefin, high molecular weight polyethylene (HMWPE), ultra-high molecular weight polyethylene (UHMWPE), polypropylene, and ultra-high molecular weight polypropylene;
a bottom layer of the first polymer material; and
a second polymer material disposed between the top and bottom layers of the first polymer material.

17. The polymer composite of claim 16, wherein the first polymer material is ultra-high molecular weight polyethylene (UHMWPE).

18. The polymer composite of claim 16, wherein the second polymer material comprises a woven aramid fabric.

19. The polymer composite of claim 16, wherein the weight ratio of the first polymer material to the second polymer material is between 2:1 and 1:2.

20. A ballistic resistant material comprising the polymer composite of claim 16.
